(19) United States
(12) Patent Application Publication
(10) Pub. No.: US 2026/0264741 A1
(43) Pub. Date: Sep. 10, 2026

(54) Steer-By-Wire System for a Motor Vehicle, and Method

(71) Applicant: Bayerische Motoren Werke Aktiengesellschaft, Muenchen (DE)

(72) Inventor: Bernhard SCHMIDT, Muenchen (DE)

(21) Appl. No.: 19/164,763

(22) PCT Filed: Feb. 5, 2024
(86) PCT No.: PCT/DE2024/100093

§ 371 Date: Sep. 12, 2025

(30) Foreign Application Priority Data
Mar. 15, 2023 (DE) 10 2023 106 470.3

(51) Int. Cl. B62D 5/00; B62D 5/04; B62D 15/02

(52) U.S. Cl. CPC B62D 5/006; B62D 5/0409; B62D 5/046; B62D 15/0215

(57) ABSTRACT

A steer-by-wire system for a motor vehicle includes at least one steering-wheel actuator having a first availability level and at least one wheel actuator having a second availability level, wherein the first availability level is lower than the second availability level. The steering-wheel actuator communicates with the wheel actuator via a communication interface. The system includes a steering-angle sensor that has a third availability level which is higher than the first availability level and is configured to communicate with the wheel actuator via the communication interface. A motor vehicle including the steer-by-wire system and a method for operating the steer-by-wire system are also disclosed.

### BACKGROUND AND SUMMARY

The invention relates to a steer-by-wire system for a motor vehicle, a motor vehicle having a steer-by-wire system and a method for operating the steer-by-wire system.

Steer-by-wire systems are already known from the prior art. In particular, in this case a steering operation is detected via a corresponding detection unit at a steering wheel and then an electrical signal of the steering operation corresponding to the detected steering input is converted by means of an actuator and therefore a wired steering operation is carried out.

DE 10 2008 026 729 A1 describes an electromechanical steering function having a system for warning a driver about a functional disturbance of the steering function, comprising means for establishing a functional disturbance, means for generating an excitation of the steering wheel, and control means, which, when a functional disturbance is established, activate the means for generating an excitation of the steering wheel for a restricted time interval in order to generate a perceptible excitation of the steering wheel. Furthermore, a method for warning a driver about a functional disturbance of an electromechanical vehicle steering function is specified.

DE 10 2018 106 872 A1 relates to a steer-by-wire steering system for motor vehicles, comprising an electronically regulated steering regulator acting on the steered wheels depending on a driving steering intention and an in feedback of the road on a control-transmitting feedback actuator, wherein the feedback actuator and the steering regulator have a separate power supply.

The object of the present invention is to provide a steer-by-wire system, a motor vehicle, and a method, by means of which a steer-by-wire steering function of the motor vehicle can be implemented in a simple manner and nonetheless reliably.

This object is achieved by a steer-by-wire system, a motor vehicle, and a method according to the independent claims. Advantageous embodiments are specified in the dependent claims.

One aspect of the invention relates to a steer-by-wire system for a motor vehicle having at least one steering wheel actuator having a first availability level and having at least one wheel actuator having a second availability level, wherein the steering wheel actuator communicates with the wheel actuator via a communication interface.

It is provided in this case that the first availability level is lower than the second availability level, wherein a steering wheel sensor having a higher third availability level than the first availability level is additionally designed for communicating via the communication interface with the wheel actuator.

In particular, it is therefore made possible that the steering wheel actuator has a lower availability level and can therefore accordingly be designed more simply. If a communication problem should occur, for example, it is thus provided that corresponding steering angle commands can be transmitted to the wheel actuator via the steering wheel sensor. In particular, the demand for a higher availability level for the steering wheel actuator therefore decreases, due to which it can be constructed simply. One or more field bus systems or digital or analog sensor interface protocols can be used here.

In particular, it is provided that the third availability level and the second availability level are equal in level. For example, the third availability level and the second availability level can correspond to an ASIL-D level. Furthermore, it can be provided that the first availability level corresponds to an ASIL-A level or an ASIL-B level or an ASIL-C level. In particular, it is therefore provided that the steering capability can nonetheless securely provide the steer-by-wire steering function even upon the use of components having, for example, lower ASIL classification and lower individual reliability. In particular, the steering wheel sensor therefore forms a redundant system for the steering wheel actuator here. In particular, it is therefore provided that, for example, additional hardware and redundant systems within the steering wheel actuator can be omitted, since the steering wheel sensor is still available as the fallback level.

Due to the separation of the so-called hand wheel actuator, thus the steering wheel actuator, from the steering wheel sensor, an independent fallback level can therefore be provided in which a steering capability can be implemented by the driver via the wheel actuator and only via the direct connection to the steering wheel sensor. The corresponding redundant supply of the steering wheel actuator and its classification as an ASIL-D component can therefore be omitted or the steering wheel actuator can be designed according to a lower safety requirement. Failsafe properties of the steering wheel actuator can be assisted here by mechanical elements or specific electrical circuitry of the steering wheel actuator.

Furthermore, it has proven to be advantageous if an electronic computing device is provided, which controls a communication between the steering wheel actuator and/or wheel actuator and/or steering wheel sensor. It can be provided here that the electronic computing device is designed to engage a communication between the steering wheel sensor and the wheel actuator in the event of a communication problem between the steering wheel actuator and the wheel actuator. It is therefore provided that if the electronic computing device should establish, for example, that a communication problem exists between the steering wheel actuator and the wheel actuator, a communication level can thus be provided between the steering wheel sensor and the wheel actuator as a fallback level. In particular, the electronic computing device can be connected to different communication interfaces of the motor vehicle, in order to thus reliably receive or generate corresponding control signals, and thus implement a reliable steering function of the steer-by-wire system.

It is likewise advantageous if two wheel actuators are provided which are each connected to one or more wheels, wherein a communication is provided between the steering wheel actuator and the two wheel actuators. In particular, the two wheel actuators are therefore provided which are arranged, for example, at a respective front wheel of the motor vehicle. The first wheel actuator and the second wheel actuator can then be actuated accordingly on the basis of an input at the steering wheel actuator. In particular, it is provided in the event of a communication problem that the steering angle sensor is also in communication with the at least two wheel actuators and can therefore carry out corresponding steering commands at the wheel actuators in the event of a failure of the steering wheel actuator.

A further advantageous embodiment provides that the communication interface is designed as a CAN bus. Alternatively or additionally, the communication interface can be provided as an ethernet interface. It is therefore possible that already reliable systems including their options for securing the communication in the motor vehicle can be used and corresponding communication protocols can be implemented between the steering wheel actuator, the wheel actuator, and the steering wheel sensor.

A further aspect of the invention relates to a motor vehicle having at least one steer-by-wire system according to the preceding aspect.

Still a further aspect of the invention relates to a method for operating a steer-by-wire system according to the preceding aspect, wherein in the event of a communication problem between the steering wheel actuator and the wheel actuator, a communication between the steering wheel sensor and the wheel actuator remains in existence.

In particular, the method is carried out by means of the steer-by-wire system.

Advantageous embodiments of the steer-by-wire system are to be viewed as advantageous embodiments of the motor vehicle and of the method. The steer-by-wire system or the motor vehicle has features of the subject matter for this purpose in order to be able to carry out corresponding method steps.

The electronic computing device comprises, for example, processors, circuits, in particular integrated circuits, and further electronic components in order to be able to carry out corresponding method steps.

Further features of the invention result from the claims, the figures, and the description of the figures. The features and combinations of features mentioned above in the description and the features and combinations of features mentioned hereinafter in the description of the figures and/or solely shown in the figures are usable not only in the respective specified combination but also in other combinations or alone.

The invention will now be explained in more detail on the basis of a preferred exemplary embodiment and with reference to the drawings. In the figures:

### BRIEF DESCRIPTION OF THE DRAWINGS

FIG. 1 shows a schematic side view of an embodiment of a motor vehicle having an embodiment of a steer-by-wire system; and

FIG. 2 shows a schematic block diagram according to an embodiment of a steer-by-wire system.

### DETAILED DESCRIPTION OF THE DRAWINGS

In the figures, identical or functionally-identical elements are provided with identical reference signs.

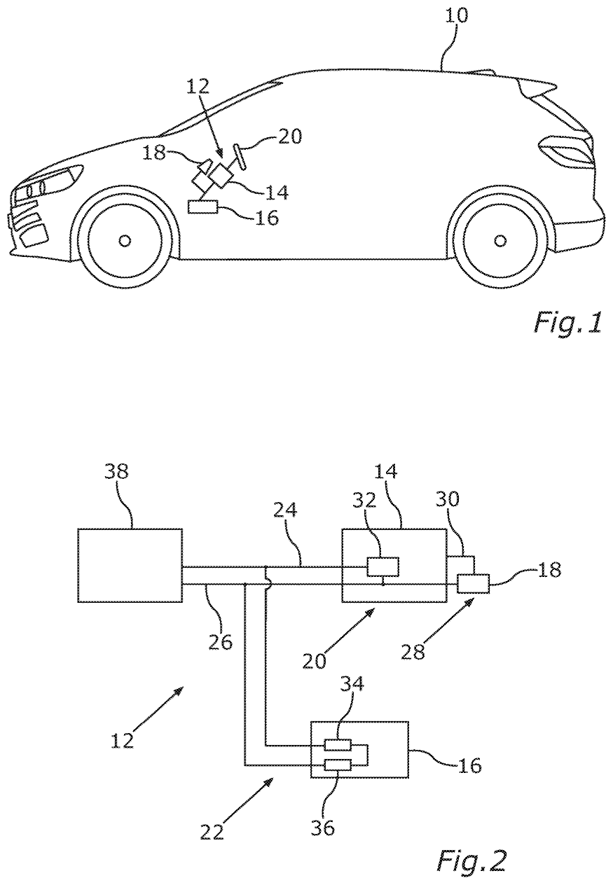

FIG. 1 shows a schematic side view of an embodiment of a motor vehicle 10. The motor vehicle 10 comprises a steer-by-wire system 12. The steer-by-wire system 12 in tum comprises a steering wheel actuator 14, at least one wheel actuator 16, and a steering angle sensor 18. In particular, the steering wheel actuator 14 is coupled, for example, with a steering wheel 20, at which a person, for example, a driver of the motor vehicle 10, can carry out a corresponding steering input. In the steer-by-wire system 12, no mechanical connection is provided between the steering wheel 20 and the wheel actuator 16. In particular, a wired communication takes place between the steering wheel actuator 14 and the at least one wheel actuator 16.

FIG. 2 shows a schematic block diagram according to one embodiment of the steer-by-wire system 12. In particular, FIG. 2 shows that the steer-by-wire system 12 comprises at least the steering actuator 14 having a first availability level 20 and the wheel actuator 16 having a second availability level 22. The steering wheel actuator 14 is coupled with the wheel actuator 16 via a communication interface 24, 26. It is provided that the first availability level 20 is lower than the second availability level 22, wherein the steering angle sensor 18 has a higher third availability level 28 than the first availability level 20 and is additionally designed for communicating via the communication interface 24, 26 with the wheel actuator 16. It is shown in the present case that a first communication interface 24 and a second communication interface 26 are provided. For example, the first communication interface 24 is an Ethernet interface and the second communication interface 26 is a CAN bus interface. However, it can alternatively or additionally also be that the first communication interface 24 is also designed as a CAN bus interface or that the second communication interface 26 is designed as an ethernet interface. In the following exemplary embodiment, the steering angle sensor 18 is supplied with a corresponding voltage by the steering wheel actuator 14 via a supply line 30.

The steering wheel actuator 14 in turn comprises a first machine 32, which is coupled via the first communication interface 24 with a further first machine 34 of the wheel actuator 16. Furthermore, a further second machine 36 is coupled using the second communication interface 26 with the first machine 32 and the steering angle sensor 18.

In particular, it is provided that the third availability level 28 and the second availability level 22 are equal in level; for example, both correspond to an ASIL-D level. The first availability level 20 can correspond, for example, to an ASIL-A level or an ASIL-B level.

Furthermore, FIG. 2 shows that an electronic computing device 38 is provided, which controls a communication between the steering wheel actuator 14 and/or the wheel actuator 16 and/or the steering angle sensor 18. The electronic computing device 38 can be designed here, in the event of a communication problem between the steering wheel actuator 14 and the wheel actuator 16, to engage a communication between the steering angle sensor 18 and the wheel actuator 16.

Furthermore, it can be provided that at least one first wheel actuator 16 is provided at a first wheel of the motor vehicle 10 and a second wheel actuator is provided at a second wheel of the motor vehicle 10, wherein a communication is provided between the steering wheel actuator 14 and the two wheel actuators 16.

In particular, it is therefore provided that an independent fallback level can be created by the separation of the steering wheel actuator 14 from the steering angle sensor 18, in which a steering capability by the driver can be implemented via the wheel actuator 16 only via the direct connection to the steering angle sensor 18. The redundant supply of the steering wheel actuator 14 and its classification as an ASIL-D component can be omitted or the steering wheel actuator 14 can be designed with a lower safety requirement.

### LIST OF REFERENCE SIGNS

10 motor vehicle
12 steer-by-wire system
14 steering wheel actuator
16 wheel actuator
18 steering angle sensor
20 first availability level
22 second availability level
24 first communication interface
26 second communication interface
28 third availability level
30 supply line
32 first machine
34 further first machine
36 further second machine
38 electronic computing device

1.-10. (canceled)

11. A steer-by-wire system for a motor vehicle, the steer-by-wire system comprising:
a steering wheel actuator having a first availability level;
a wheel actuator having a second availability level that is higher than the first availability level;
a communication interface, via which the steering wheel actuator communicates with the wheel actuator; and
a steering wheel sensor having a third availability level that is higher than the first availability level, wherein the steering wheel sensor is configured to communicate with the wheel actuator via the communication interface.

12. The steer-by-wire system according to claim 11, wherein the third availability level and the second availability level are equal.

13. The steer-by-wire system according to claim 11, wherein the third availability level and the second availability level correspond to an ASIL-D level.

14. The steer-by-wire system according to claim 12, wherein the third availability level and the second availability level correspond to an ASIL-D level.

15. The steer-by-wire system according to claim 11, wherein the first availability level corresponds to an ASIL-A level, an ASIL-B level, or ASIL-C level.

16. The steer-by-wire system according to claim 12, wherein the first availability level corresponds to an ASIL-A level, an ASIL-B level, or ASIL-C level.

17. The steer-by-wire system according to claim 13, wherein the first availability level corresponds to an ASIL-A level, an ASIL-B level, or ASIL-C level.

18. The steer-by-wire system according to claim 11, further comprising an electronic computing device configured to control communication between at least two of the steering wheel actuator, the wheel actuator, and the steering angle sensor.

19. The steer-by-wire system according to claim 12, further comprising an electronic computing device configured to control communication between at least two of the steering wheel actuator, the wheel actuator, and the steering angle sensor.

20. The steer-by-wire system according to claim 13, further comprising an electronic computing device configured to control communication between at least two of the steering wheel actuator, the wheel actuator, and the steering angle sensor.

21. The steer-by-wire system according to claim 18, wherein the electronic computing device is configured to engage the communication between the steering angle sensor and the wheel actuator based on a determination that there is a communication problem between the steering wheel actuator and the wheel actuator.

22. The steer-by-wire system according to claim 11, wherein a first wheel actuator is provided at a first wheel of the motor vehicle and a second wheel actuator is provided at a second wheel of the motor vehicle, and wherein a communication is provided between the steering wheel actuator and the first and second wheel actuators.

23. The steer-by-wire system according to claim 12, wherein a first wheel actuator is provided at a first wheel of the motor vehicle and a second wheel actuator is provided at a second wheel of the motor vehicle, and wherein a communication is provided between the steering wheel actuator and the first and second wheel actuators.

24. The steer-by-wire system according to claim 13, wherein a first wheel actuator is provided at a first wheel of the motor vehicle and a second wheel actuator is provided at a second wheel of the motor vehicle, and wherein a communication is provided between the steering wheel actuator and the first and second wheel actuators.

25. The steer-by-wire system according to claim 11, wherein the communication interface is configured as a field bus system.

26. The steer-by-wire system according to claim 12, wherein the communication interface is configured as a field bus system.

27. The steer-by-wire system according to claim 13, wherein the communication interface is configured as a field bus system.

28. A motor vehicle comprising a steer-by-wire system according to claim 11.

29. A method for operating a steer-by-wire system according to claim 11, wherein a communication is engaged between the steering angle sensor and the wheel actuator based on a determination that there is a communication problem between the steering wheel actuator and the wheel actuator.
